(19) United States
(12) Patent Application Publication
(10) Pub. No.: US 2016/0059711 A1
(43) Pub. Date: Mar. 3, 2016

(54) MULTI-LINK POWER-SPLIT ELECTRIC POWER SYSTEM FOR AN ELECTRIC-HYBRID POWERTRAIN SYSTEM

(71) Applicant: GM GLOBAL TECHNOLOGY OPERATIONS LLC, Detroit, MI (US)

(72) Inventors: Alan G. Holmes, Clarkston, MI (US); Peter J. Savagian, Bloomfield Hills, MI (US)

(21) Appl. No.: 14/468,898

(22) Filed: Aug. 26, 2014

(51) Int. Cl. B60L 11/12; B60L 7/16; H02P 5/74

(52) U.S. Cl. CPC B60L 11/12; H02P 5/74; B60L 7/16; Y10S 903/906

(57) ABSTRACT

A powertrain system includes a multi-link power-split electric power system including first and second electric machines. The first electric machine mechanically rotatably couples to a drive wheel and the second electric machine mechanically rotatably couples to an internal combustion engine. The first electric machine electrically connects in series between first and second inverters. The first inverter electrically connects to a first high-voltage DC electric power bus and the second inverter electrically connects to a second high-voltage DC electric power bus. The second electric machine electrically connects to a third inverter that electrically connects to the second high-voltage DC electric power bus.

### TECHNICAL FIELD

This disclosure relates to electric-hybrid powertrain systems, and associated electrical architectures.

### BACKGROUND

The statements in this section merely provide background information related to the present disclosure and may not constitute prior art.

Electric-hybrid powertrain systems use multi-phase electric machines in the form of generators and motor/generators to generate and convert electric power to tractive effort and to convert mechanical torque originating from an internal combustion engine or vehicle momentum to electric power through electric power generation and regenerative braking operations in response to operator commands.

### SUMMARY

A powertrain system includes a multi-link power-split electric power system including first and second electric machines. The first electric machine mechanically rotatably couples to a drive wheel and the second electric machine mechanically rotatably couples to an internal combustion engine. The first electric machine electrically connects in series between first and second inverters. The first inverter electrically connects to a first high-voltage DC electric power bus and the second inverter electrically connects to a second high-voltage DC electric power bus. The second electric machine electrically connects to a third inverter that electrically connects to the second high-voltage DC electric power bus.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

One or more embodiments will now be described, by way of example, with reference to the accompanying drawings, in which:

FIG. 1 schematically illustrates a Multi-Link Power-Split electric power (MLPS) system including multiple inverter modules and multiple electric machines including a first electric machine electrically connected in series between first and second inverters and a second electric machine electrically connected to a third inverter, in accordance with the disclosure;

FIG. 2 schematically illustrates a first powertrain system that incorporates an embodiment of the MLPS system described with reference to FIG. 1, including multiple inverter modules and multiple electric machines, an internal combustion engine and a drive wheel, in accordance with the disclosure; and

FIG. 3 schematically illustrates a second powertrain system that incorporates an embodiment of the MLPS system described with reference to FIG. 1, including multiple inverter modules and multiple electric machines, an internal combustion engine and a drive wheel, in accordance with the disclosure.

### DETAILED DESCRIPTION

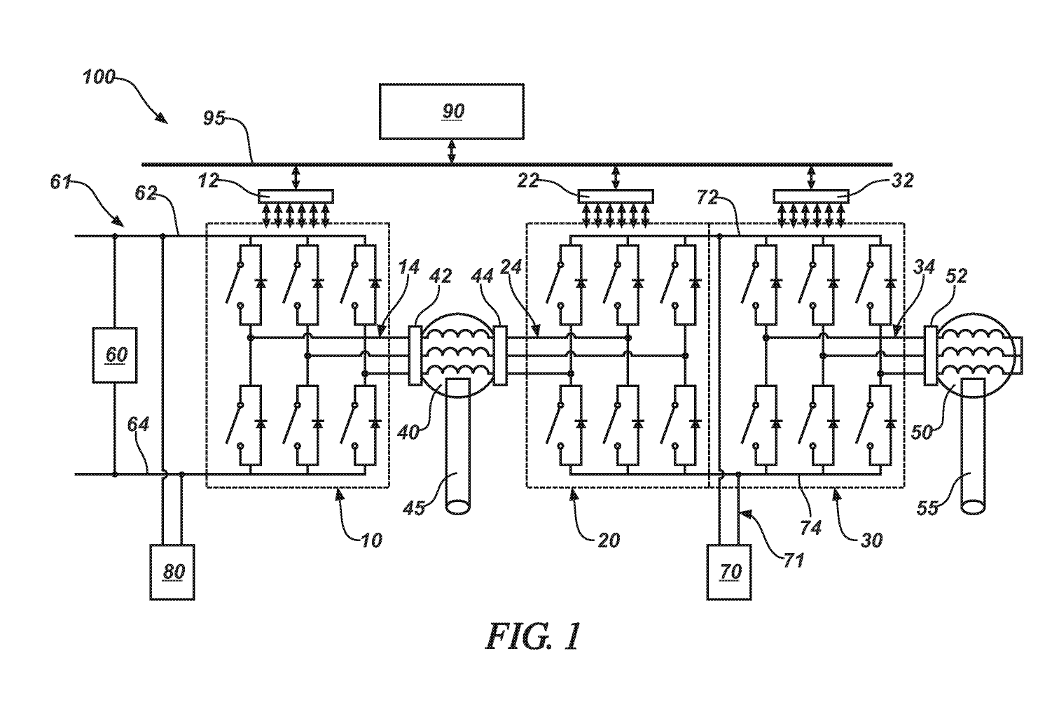

Referring now to the drawings, wherein the depictions are for the purpose of illustrating certain exemplary embodiments only and not for the purpose of limiting the same, FIG. 1 schematically illustrates a Multi-Link Power-Split electric power (MLPS) system 100 including multiple inverter modules and multiple electric machines arranged in accordance with this disclosure. The “multi-link” refers to the use of two electrically independent high-voltage DC power links or buses, and the term “power-split” refers to the use of two independently controlled electric machines for generating either or both electric power and torque. As shown, the MLPS system 100 includes a first inverter module 10, a second inverter module 20, a third inverter module 30, a first electric machine 40 and a second electric machine 50, the operation of which is controlled by controller 90. The MLPS system 100 is used on various powertrain system configurations to provide tractive torque, regenerative braking torque, electric power generation and related functions.

The first electric machine 40 and the second electric machine 50 are multi-phase, multi-pole electric motor/generators each including a rotor and stator, and operate as torque motors to transform electric power to mechanical torque or as generators to transform mechanical torque to electric power. The rotor of the first electric machine 40 rotatably couples to a first member 45 to effect torque transfer and the rotor of the second electric machine 50 rotatably couples to a second member 55 to effect torque transfer. The first and second electric machines 40 and 50 are both three-phase devices in one embodiment and as shown, although other multi-phase configurations may be employed without limitation.

A first high-voltage power supply 60 electrically connects to a first high-voltage DC power bus 61 including a positive rail 62 and a negative rail 64. In one embodiment, the first high-voltage power supply 60 is an electrochemical storage battery. In one embodiment an external charging system 80 electrically connects to the positive rail 62 and the negative rail 64 to externally charge the first high-voltage power supply 60. In one embodiment, the external charging system electrically connects to a stationary power supply to effect charging using AC power under specific conditions. A second high-voltage power supply 70 electrically connects to a second high-voltage DC power bus 71 including a positive rail 72 and a negative rail 74. The magnitude of voltage potential across the first high-voltage DC power bus 61 differs from the magnitude of voltage potential across the second high-voltage DC power bus 71 in one embodiment.

Each of the first, second and third inverter modules 10, 20 and 30 includes a plurality of complementary paired switch devices electrically connected in series between the positive and negative sides of the associated high-voltage DC power bus with each of the paired switch devices associated with one of the phases of the corresponding electric machine. As shown, the first inverter module 10 electrically connects between the positive rail 62 and the negative rail 64 of the first high-voltage DC power bus 61, and the second and third inverter modules 20, 30 electrically connect between the positive rail 72 and the negative rail 74 of the second high-voltage DC power bus 71. Each of the paired switch devices is a suitable high-voltage switch, e.g., a semi-conductor device effectively having low ON impedance that is preferably an order of magnitude of milli-ohms for the average currents through the switch. In one embodiment, the paired switch devices are insulated gate bipolar transistors (IGBT). In one embodiment, the paired switch devices are field-effect transistor (FET) devices. In one embodiment, the FET devices may be MOSFET devices. The paired switch devices are configured as pairs to control electric power flow between the positive side of the corresponding high-voltage DC power bus and one of the electric cables connected to and associated with one of the phases of the corresponding electric machine and the negative side of the corresponding high-voltage DC power bus. Each of the first, second and third inverter modules 10, 20 and 30 may also include other electric circuit elements such as high-voltage DC link capacitors, resistors, and active DC bus discharge circuits.

The first inverter module 10 includes a first multi-phase AC power bus 14 that electrically connects to a first power coupler 42 of the first electric machine 40, including electrically connecting to a first side of each of the phases thereof. The second inverter module 20 includes a second multi-phase AC power bus 24 that electrically connects to a second power coupler 44 of the first electric machine 40, including electrically connecting to a second side of each of the phases thereof. The series connection between the first inverter module 10, the first electric machine 40 and the second inverter module 20 is thus arranged in one embodiment. When either the first inverter module 10 or the second inverter module 20 is switched to an all-phase high condition or an all-phase low condition, the other inverter sees the first electric machine in a star configuration. Thus an operating condition such as occurrence of fault in one of the first and second inverter modules 10, 20 does not result in a forced shut-down of the first electric machine 40. The third inverter module 30 includes a third multi-phase AC power bus 34 that electrically connects to a first power coupler 52 of the second electric machine 50, including electrically connecting to a first side of each of the phases thereof. The second sides of the phases of the second electric machine 50 electrically connect to form a star configuration as shown. Alternatively, the second sides of the phases of the second electric machine 50 electrically connect through the first power coupler 52 in a delta configuration (not shown in FIG. 1). The first, second and third inverter modules 10, 20, 30 are preferably configured as voltage-source inverters (VSI) in either a pulsewidth-modulated (PWM) VSI mode or a six-step VSI mode. Furthermore, the first, second and third inverter modules 10, 20, 30 may operate in the PWM VSI mode under some operating conditions such as low load, and operate in the six-step VSI mode under other operating conditions, such as high load. Alternatively, the first, second and third inverter modules 10, 20, 30 may be otherwise configured without limitation.

Gate drive modules 12, 22 and 32, respectively, each include a plurality of paired gate drive circuits, each which signally individually connects to one of the complementary paired switch devices of one of the phases of the respective one of the first, second and third inverter modules 10, 20 and 30. There are three paired gate drive circuits or a total of six gate drive circuits in each of the gate drive modules 12, 22 and 32 when the corresponding electric machine is a three-phase device. The gate drive modules 12, 22 and 32 receive operating commands from the controller 90 via communications bus 95 and control activation and deactivation of each of the switch devices via the gate drive circuits to provide motor drive functionality or electric power generation functionality that is responsive to operating commands. Operating commands may include vehicle acceleration or vehicle braking when the MLPS system 100 is deployed on a vehicle as an element of a powertrain system for generating tractive torque. During operation, each of the gate drive modules 12, 22 and 32 generates a pulse in response to a control signal originating from the controller 90, which activates one of the switch devices and induces current flow through a half-phase of the stator of the respective electric machine to generate torque in the rotor in response to operating commands.

Each of the first and second gate drive modules 12, 22 electrically connects to the plurality of complementary paired switch devices of the corresponding first and second inverter module 10, 20, and operates to periodically and repetitively activate the complementary paired switch devices to transfer electric power between one of the positive and negative sides of the associated high-voltage DC power bus and a plurality of windings associated with one of the phases of the stator of the first torque machine 40 to transform electric power to mechanical torque and to transform mechanical torque to electric power through shaft 45 that mechanically couples to the respective rotor. Similarly, the third gate drive module 32 electrically connects to the plurality of complementary paired switch devices of the third inverter module 30, and operates to periodically and repetitively activate the complementary paired switch devices to transfer electric power between one of the positive and negative sides of the second high-voltage DC power bus 71 and a plurality of windings associated with one of the phases of the stator of the second torque machine 50 to transform electric power to mechanical torque and to transform mechanical torque to electric power through shaft 55 that mechanically couples to the respective rotor.

Controller, control module, module, control, control unit, processor and similar terms mean any one or various combinations of one or more of Application Specific Integrated Circuit(s) (ASIC), electronic circuit(s), central processing unit(s) (preferably microprocessor(s)) and associated memory and storage (read only, programmable read only, random access, hard drive, etc.) executing one or more software or firmware programs or routines, combinational logic circuit(s), input/output circuit(s) and devices, appropriate signal conditioning and buffer circuitry, and other components to provide the described functionality. Software, firmware, programs, instructions, routines, code, algorithms and similar terms mean any controller-executable instruction sets including calibrations and look-up tables. The controller has a set of control routines executed to provide desired functions. Routines are executed, such as by a central processing unit, and are operable to monitor inputs from sensing devices and other networked control modules, and execute control and diagnostic routines to control operation of actuators. The communications bus 95 can include any suitable communications configuration, including, by way of example, communications via direct wiring, via a controller area network, or via a wireless network.

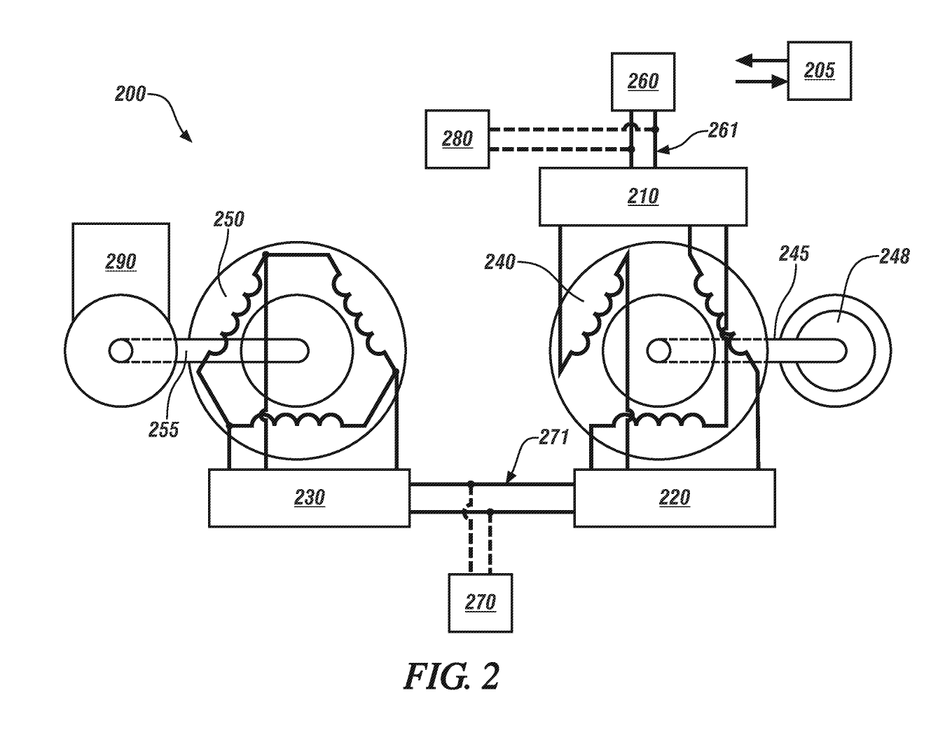

FIG. 2 schematically illustrates a first powertrain system 200 that incorporates an embodiment of the MLPS system 100 described with reference to FIG. 1, including multiple inverter modules and multiple electric machines, an internal combustion engine and a drive wheel. As shown, the first powertrain system 200 includes a first inverter module 210, a second inverter module 220, a third inverter module 230, a first electric machine 240, one or a plurality of drive wheel(s) 248, a second electric machine 250 and an internal combustion engine 290. Operation is controlled by a controller 205. The first electric machine 240 and the second electric machine 250 are multi-phase, multi-pole electric motor/generators that each include a rotor and stator, and operate as torque motors to transform electric power to mechanical torque and/or as generators to transform mechanical torque to electric power. The rotor of the first electric machine 240 rotatably couples to a first member 245 that rotatably couples to the drive wheel(s) 248 to effect torque transfer thereto. Torque transfer can be in the form of positive tractive torque to effect vehicle acceleration, or in the form of negative or reactive torque to effect vehicle deceleration in a regenerative braking mode. The rotatable coupling between the first electric machine 240, the first member 245 and the drive wheel(s) 248 may employ other mechanical torque transfer elements without limitation, such as planetary gears, differential gears, torque converters, clutches and the like. The rotor of the second electric machine 250 rotatably couples to a second member 255 that rotatably couples to the internal combustion engine 290 to effect torque transfer in an electric power generation mode. The first and second electric machines 240 and 250 are both three-phase devices in one embodiment and as shown, although other multi-phase configurations may be employed without limitation. The first powertrain system 200 is analogous to a series hybrid electric vehicle, wherein all power generated by the internal combustion engine 290 is converted to electric power that is used by the first electric machine 240 to generate torque or is stored as electric power. The first powertrain system 200 is incapable of directly mechanically coupling the internal combustion engine 290 to the drive wheel(s) 248, i.e., the drive wheel(s) 248 is permanently mechanically decoupled from the internal combustion engine 290.

In this embodiment, a first high-voltage power supply 260 electrically connects to a first high-voltage DC power bus 261. In some embodiments the first high-voltage power supply 260 is an electrochemical storage battery with sufficient power to propel a vehicle (not shown). In one embodiment an external charging system 280 electrically connects to the first high-voltage DC power bus 261 to externally charge the first high-voltage power supply 260 under specific conditions. In one embodiment a second high-voltage power supply 270 electrically connects to a second high-voltage DC power bus 271. In one embodiment the second high-voltage power supply 270 is an electric capacitor. The magnitude of voltage potential across the first high-voltage DC power bus 261 differs from the magnitude of voltage potential across the second high-voltage DC power bus 271 in one embodiment. In one embodiment, the voltage potential across the second high-voltage DC power bus 271 varies across a greater range than the voltage potential across the first high-voltage DC power but 261.

Each of the first, second and third inverter modules 210, 220 and 230 is constructed and controlled in a manner analogous to the first, second and third inverter modules 10, 20 and 30 described with reference to FIG. 1. As shown, the first inverter module 210 electrically connects to the first high-voltage DC power bus 261, and the second and third inverter modules 220, 230 electrically connect to the second high-voltage DC power bus 271. The first inverter module 210 includes a first multi-phase AC power bus that electrically connects to the first electric machine 240, including electrically connecting to a first side of each of the phases thereof. The second inverter module 220 includes a second multi-phase AC power bus that electrically connects to the first electric machine 240, including electrically connecting to a second side of each of the phases thereof. The series connection between the first inverter module 210, the first electric machine 240 and the second inverter module 220 is thus configured in one embodiment. The third inverter module 230 includes a third multi-phase AC power bus that electrically connects to the second electric machine 250, including electrically connecting to a first side of each of the phases thereof. The second sides of the phases of the second electric machine 250 are electrically connected to form a delta configuration. Alternatively, the second sides of the phases of the second electric machine 250 are connected to form a star configuration (not shown in FIG. 2). Gate drive modules analogous to the gate drive modules 12, 22 and 32 described with reference to FIG. 1 are employed to periodically and repetitively activate the complementary paired switch devices to transfer electric power between one of the positive and negative sides of the associated high-voltage DC power bus and a plurality of windings associated with one of the phases of the respective first torque machine 240 or second torque machine 250 to transform electric power to mechanical torque and to transform mechanical torque to electric power.

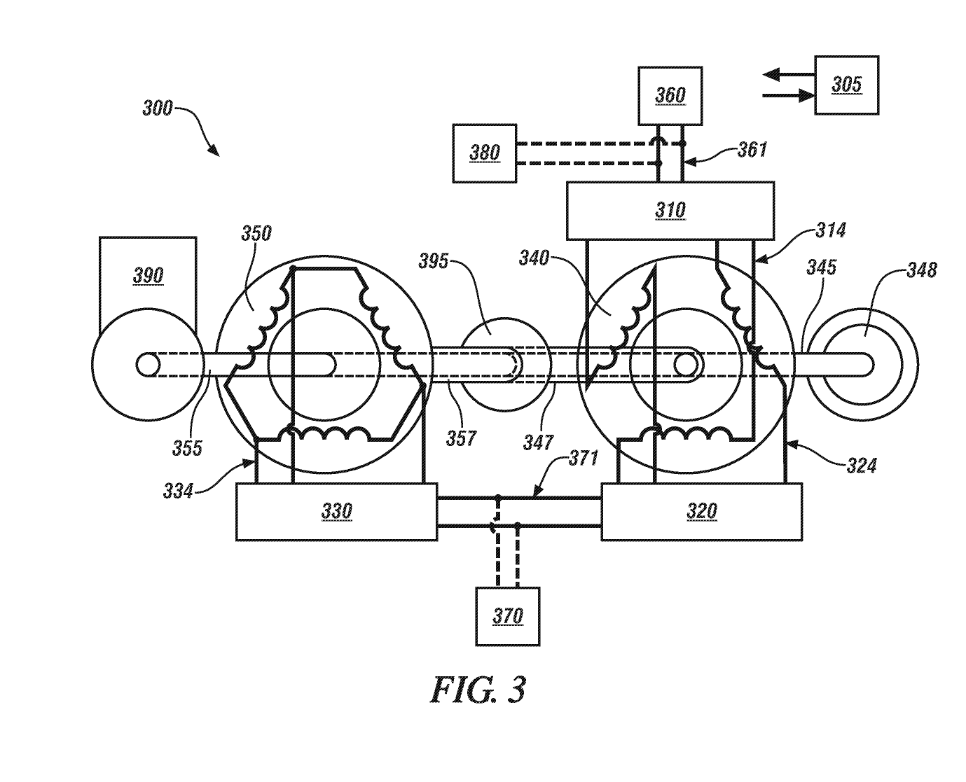

FIG. 3 schematically illustrates a second powertrain system 300 that incorporates an embodiment of the MLPS system 100 described with reference to FIG. 1, including multiple inverter modules and multiple electric machines, an internal combustion engine and a drive wheel. As shown, the second powertrain system 300 includes a first inverter module 310, a second inverter module 320, a third inverter module 330, a first electric machine 340, a drive wheel 348, a second electric machine 350, an internal combustion engine 390 and a torque coupling device 395. Operation is controlled by a controller 305. The first electric machine 340 and the second electric machine 350 are multi-phase, multi-pole electric motor/generators that each include a rotor and stator, and operate as torque motors to transform electric power to mechanical torque and/or as generators to transform mechanical torque to electric power. The rotor of the first electric machine 340 rotatably couples to a first member 347 that rotatably couples to the torque coupling device 395 to effect torque transfer thereto. The torque coupling device 395 rotatably couples to a third member 345 that rotatably couples to the drive wheel 348 to effect torque transfer thereto. In the embodiment shown, a portion of the third member 345 extends concentrically through the first member 347. The couplings among the first electric machine 340, the first member 347, the torque coupling device 395, the third member 345 and the drive wheel 348 may employ other mechanical torque transfer elements without limitation, such as planetary gears, differential gears, clutches and the like. The rotor of the second electric machine 350 rotatably couples to a second member 357 that rotatably couples to the torque coupling device 395 to effect torque transfer therefrom. The torque coupling device 395 rotatably couples to a fourth member 355 that rotatably couples to the internal combustion engine 390 to effect torque transfer therefrom. In the embodiment shown, a portion of the fourth member 355 extends concentrically through the second member 357. The rotatably coupling among the second electric machine 350, the second member 357, the torque coupling device 395, the fourth member 355 and the internal combustion engine 390 may employ other mechanical torque transfer elements without limitation, such as planetary gears, differential gears, clutches, and the like. The first and second electric machines 340 and 350 are both three-phase devices in one embodiment and as shown, although other multi-phase configurations may be employed without limitation. The torque coupling device 395 mechanically couples the first member 347 and the second member 357, and can include one or a combination of a planetary or other gearing set, a belt-drive, a clutch, a torque converter, or another device(s) without limitation. The torque coupling device 395 mechanically couples the drive wheel(s) 348 and the engine 390 to effect torque transfer therebetween, with the mechanical coupling arranged permanently or in a selectively activatable arrangement using a controllable element such as a clutch. In some embodiments, the torque coupling device 395 includes an interconnected pair of planetary gear sets in which the speeds of the first member 347, second member 357, third member 345 and fourth member 355 are a linear combination of one another with two independent speeds. In one embodiment, the speed of the first member 347 may be a multiple of the speed of the third member 345 and the speed of the fourth member 355 is a weighted average of the speeds of the second member 357 and the third member 345. The second powertrain system 300 may be a multi-mode power-split powertrain system that can operate in a fixed gear state, a continuously variable gear state, or an electric vehicle state, wherein mechanical power generated by the internal combustion engine 390 is selectively employed to provide tractive torque to drive the wheel(s) 348 and/or is converted to electric power used by the first electric machine 340 to generate torque or be stored as electric power. The second powertrain system 300 includes directly mechanically coupling the internal combustion engine 290 to the drive wheel(s) 248 through the torque coupling device 395.

In this embodiment, a first high-voltage power supply 360 electrically connects to a first high-voltage DC power bus 361. In some embodiments, the first high-voltage power supply 360 is an electrochemical storage battery with sufficient power to propel a vehicle (not shown). In one embodiment an external charging system 380 electrically connects to the first high-voltage DC power bus 361 to externally charge the first high-voltage power supply 360 under specific conditions. In one embodiment, a second high-voltage power supply 370 electrically connects to a second high-voltage DC power bus 371. In one embodiment, the second high-voltage power supply 370 is an electric capacitor. The magnitude of voltage potential across the first high-voltage DC power bus 361 differs from the magnitude of voltage potential across the second high-voltage DC power bus 371 in one embodiment. In an embodiment, the voltage potential across the second high-voltage DC power bus 371 varies across a greater range than the voltage potential across the first high-voltage DC power but 361.

Each of the first, second and third inverter modules 310, 320 and 330 is constructed and controlled in a manner analogous to the first, second and third inverter modules 10, 20 and 30 described with reference to FIG. 1. As shown, the first inverter module 310 electrically connects to the first high-voltage DC power bus 361, and the second and third inverter modules 320, 330 electrically connect to the second high-voltage DC power bus 371. The first inverter module 310 includes a first multi-phase AC power bus 314 that electrically connects to the first electric machine 340, including electrically connecting to a first side of each of the phases thereof. The second inverter module 320 includes a second multi-phase AC power bus 324 that electrically connects to the first electric machine 340, including electrically connecting to a second side of each of the phases thereof. The series connection between the first inverter module 310, the first electric machine 340 and the second inverter module 320 is thus configured in one embodiment. The third inverter module 330 includes a third multi-phase AC power bus 334 that electrically connects to the second electric machine 350, including electrically connecting to a first side of each of the phases thereof. The second sides of the phases of the second electric machine 350 are electrically connected to form a star configuration. Gate drive modules analogous to the gate drive modules 12, 22 and 32 described with reference to FIG. 1 are employed to periodically and repetitively activate the complementary paired switch devices to transfer electric power between one of the positive and negative sides of the associated high-voltage DC power bus and a plurality of windings associated with one of the phases of the respective first torque machine 340 or second torque machine 350 to transform electric power to mechanical torque and to transform mechanical torque to electric power.

Powertrain systems incorporating an embodiment of the MLPS system 100 described with reference to FIG. 1 are configured in a manner that allows the first electric machine rotatably coupled to the drive wheel(s) to have direct access to electric power originating from the first high-voltage power supply and electric power originating from the second electric machine while functioning in generator mode, including operating at two different DC voltage levels. The first electric machine rotatably coupled to the drive wheel(s) can be driven directly from the first high-voltage power supply for electric vehicle operation, and electric power from the first electric machine can be stored directly in the first high-voltage power supply during regenerative braking. Furthermore, the first electric machine can be driven directly from the second electric machine in generator mode for power-split transmission operation. Furthermore, two different bus voltage levels can be combined in a power-split hybrid without the use of a separate inductor for a DC-DC converter. The voltage of the power bus connecting the first and second electric machines can be controlled to optimize the efficiency of power transfer between them, while the voltage of the power bus connecting the first electric machine with the high-voltage power supply can be controlled to control the charging or discharging thereof. Furthermore, power to and from the second high-voltage power supply suffers only the conduction losses of the two switches forming the star point in the second electric machine without additional switching or inductor losses, thus minimizing electric current conduction losses.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

1. A powertrain system, comprising:
a multi-link power-split electric power system including first and second electric machines, the first electric machine mechanically rotatably coupled to a drive wheel and the second electric machine mechanically rotatably coupled to an internal combustion engine;
said first electric machine electrically connected in series between first and second inverters, said first inverter electrically connected to a first high-voltage DC electric power bus and said second inverter electrically connected to a second high-voltage DC electric power bus; and
said second electric machine electrically connected to a third inverter, said third inverter electrically connected to the second high-voltage DC electric power bus.

2. The powertrain system of claim 1, further comprising the first high-voltage DC electric power bus electrically connected to a first high-voltage energy storage device and the second high-voltage DC electric power bus electrically connected to a second high-voltage energy storage device.

3. The powertrain system of claim 2, wherein the first high-voltage energy storage device comprises an electrochemical battery and the second high-voltage DC electric power bus comprises a high-voltage capacitor.

4. The powertrain system of claim 2, further comprising the first high-voltage energy storage device connectable to an external charging system.

5. The powertrain system of claim 1, wherein said first inverter electrically connected to a first high-voltage DC electric power bus and said second inverter electrically connected to a second high-voltage DC electric power bus further comprises said first inverter electrically connected to the first high-voltage DC electric power bus electrically connected to a first high-voltage energy storage device operating at a first voltage potential and said second inverter electrically connected to the second high-voltage DC electric power bus electrically connected to a second high-voltage energy storage device operating at a second voltage potential, said first voltage potential different from said second voltage potential.

6. The powertrain system of claim 5, wherein the first high-voltage energy storage device and the first high-voltage DC electric power bus are electrically independent from the second high-voltage energy storage device and the second high-voltage DC electric power bus.

7. The powertrain system of claim 1, wherein the first electric machine mechanically rotatably coupled to the drive wheel comprises the first electric machine configured as a motor/generator to generate tractive torque and generate regenerative braking torque.

8. The powertrain system of claim 1, wherein the second electric machine mechanically rotatably coupled to the internal combustion engine comprises the second electric machine configured only as an electric power generator.

9. The powertrain system of claim 1, further comprising the drive wheel permanently mechanically decoupled from the engine.

10. A powertrain system, comprising:
first and second electric machines mechanically coupled to a hybrid transmission in a power-split configuration, including the first electric machine mechanically coupled to a drive wheel and the second electric machine mechanically coupled to an internal combustion engine;
said first electric machine electrically connected in series between first and second inverters, said first inverter electrically connected via a first high-voltage DC electric power bus to a first high-voltage battery and said second inverter electrically connected via a second high-voltage DC electric power bus to a second high-voltage battery; and
said second electric machine electrically connected to a third inverter, said third inverter electrically connected via the second high-voltage DC electric power bus to the second inverter and the second high-voltage battery.

11. The powertrain system of claim 10, wherein the first high-voltage DC electric power bus is electrically independent from the second high-voltage DC electric power bus.

12. The powertrain system of claim 10, further comprising the first electric machine mechanically coupled to an input member of the hybrid transmission to generate tractive torque.

13. The powertrain system of claim 10, further comprising a rotor of the first electric machine rotatably coupled to a first member rotatably coupled to a torque coupling device.

14. The powertrain system of claim 13, further comprises a rotor of the second electric machine rotatably coupled to a second member that rotatably couples to the torque coupling device.

15. The powertrain system of claim 14, further comprising the torque coupling device rotatably coupled to a third member rotatably coupled to the drive wheel.

16. The powertrain system of claim 15, further comprising the third member extending concentrically through the first member.

17. The powertrain system of claim 16, further comprising the torque coupling device rotatably coupled to a fourth member rotatably coupled to the internal combustion engine.

18. The powertrain system of claim 17, wherein the torque coupling device comprises a planetary gear set.

19. A multi-link power-split electric power system for an electric-hybrid powertrain system, comprising:
a first inverter module electrically connected to a first electrical energy storage device via a first high-voltage DC power bus;
a second inverter module electrically connected to a second electrical energy storage device via a second high-voltage DC power bus;
a first electric machine electrically connected in series between the first inverter module and the second inverter module; and
a third inverter module electrically connected to the second electrical energy storage device via the second high-voltage power bus, said third inverter module electrically connected to a second electric machine configured to generate electric power from a torque generating device.

20. The multi-link power-split electric power system of claim 18, wherein the first electrical energy storage device and first high-voltage DC power bus are electrically independent from the second high-voltage energy storage device and the second high-voltage DC power bus.
